(19) United States
(12) Patent Application Publication
(10) Pub. No.: US 2003/0173466 A1
(43) Pub. Date: Sep. 18, 2003

(54) Spaceshuttle observatory

(76) Inventor: Zoltan Herpay, London (GB)

Correspondence Address: Dr. Zoltan Herpay, 28 Dudley Court, 36 Endell Street, London, WC2 9RD, GB

(21) Appl. No.: 10/100,733

(22) Filed: Mar. 18, 2002

(51) Int. Cl. B64G 1/22; B64G 1/00

(52) U.S. Cl. 244/158 R

(57) ABSTRACT

A Spaceshuttle Observatory of a singular system that creates its observatory in its fuselage telescopically on two possible ways, when the large body arrives to space, and the observatory is opened out (A) towards the tail, by leaving the observatory and its main reflector at the top-cone, and pulling the secondary reflector down, as the central tank is slipping out, or it is the secondary reflector which is fixed at the top inside a number of opened star-doors, and the downwardly slipping central fuel tank is pulling the main reflector with its observatory to the center of the fuselage, in this case with the possibility of saving the central tank and engine. In both cases there is a need for turning the wing tips towards the sun.

This invention relates to a spaceshuttle observatory of a singular system, in which the central part of the fuselage of a large spaceshuttle provides means for the opening of observatory in two different ways.

In the present art a spaceshuttle and an observatory, like the Hubble Observatory, are operative in separtion from each other. The spaceshuttle could not offer the works of a great observatory, while the Hubble Observatory can not facilitate a reentry, and if troubled, it would need the support of a great visiting station. Still another complain that the Hubble Observatory is not yet reported any visibility of a planet alongside of the nearby stars, nor did it any report about the outermost “edge-region” of our observational Universe, and it is most particularly silent about the tremendously sized implosion towards us, the true originator of life-carriers, which occasionally are falling successfully into our atmosphere. Our sciences are tending to be antisynergetized and life-degenerative, because the true nature of the observational Universe is not yet known. Everything is mediocre in the facilitating the leading science of cosmology and astronomy.

According to the present invention there is a possibility to overcome at least some of the mentioned problems by making a systemic unity from a large, self-lifting spaceshuttle and from a relatively great observatory that could be made useful in the central part of the fuselage in two different ways, in both cases by the sliding out of the large and wide central tank CT and its main engine E, either by pulling down the secondary reflector and jettisoning the empty central tank with its big engine, making the telescope open towards the tail of the spaceshuttle, and leaving the observatory in the nose-cone in a relatively great distance from the still filled fuel tanks, or by pulling the observatory and its main reflector towards the centre of the long fuselage by the outwardly moving central tank, that might stay with the system, leaving the secondary reflector at the top nose-cone that could be opened with a number of star-doors S. In both case there is a need for using the turnable wing tips as solar-radiation collectors, with effective sizes.T.

Though this invention could be supported with one of my oldest ultra-light reflectors, this latter proposition does not belong to the present invention.

A specific embodiment of the invention will now be described by way of example with reference to the accompanuing drawing in which:

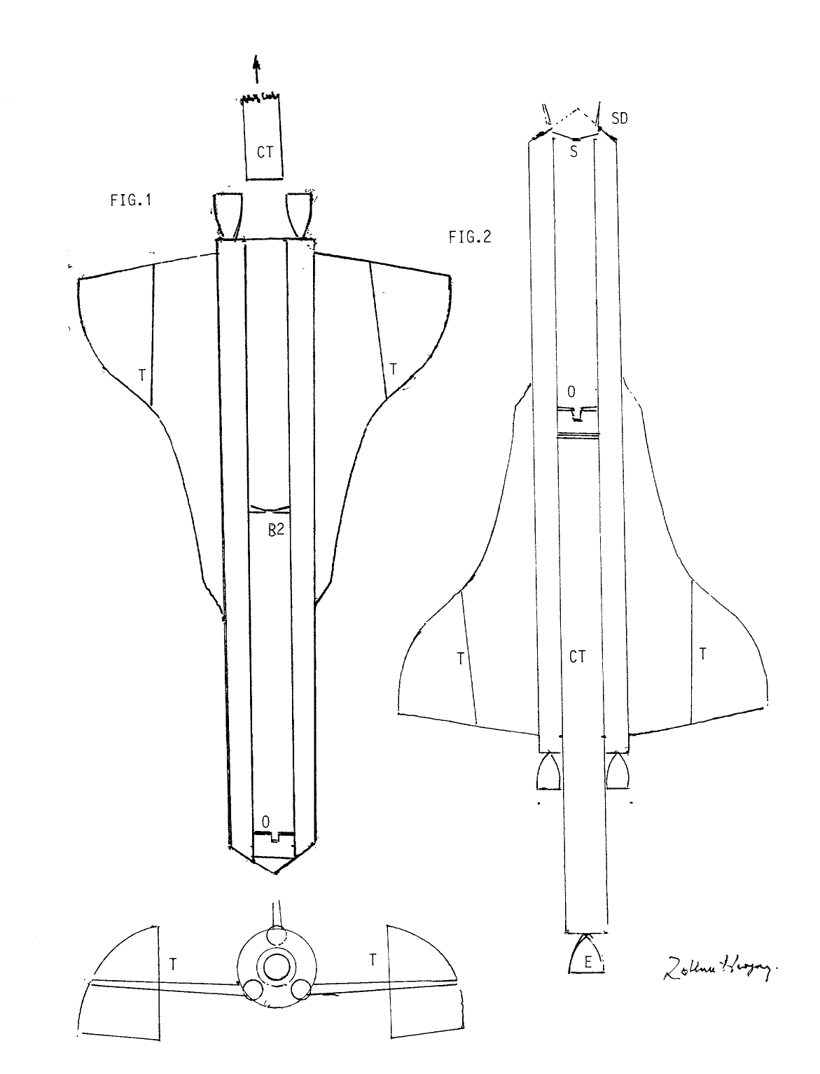

FIG. 1 shows the top planar view of the unified system as it is pulled the secondary reflector R2 towards the centre of the fuselage, while the large central tank CT is jettisoned and the two wing tips are turnable at T.

FIG. 2 shows the same top planar cross-section, but in this time it is the secondary reflector, which is fixed at the top of the nose-cone, whose star-doors are open SD, and it is the main reflector with its supporting observatory O which is pulled to the centre of the bigh outer fuel tank-fuselage by the outwardly slipping central fuel tank of the fuselage, which in this second case, not necessarily jettisoned.

FIG. 3 shows the back side view of the spaceshuttle observatory with its double-ringed fuselage, in which the central fuel tank CT is relatively wide yet it might have a singular big engine. The wing tips are turned out at T for holding their surfaces towards the sun.

Referring to FIG. 1 it might be difficult to select one out from the two possible configurations, for the making of a super-light reflector is probably not yet known, and the lifting out of a large, very heavy reflector might cause problems. The fixed observatory at the top of the fuselAge seems to be safer in position, but its back part is not shielded well, except only by the ablation layers. With the jettisoned central fuel tank and its main engine the system is becoming lighter. No extra doors and their openings are required. When it is the observatory and its main reflector which is pulled to the centre of the fuselage's outer tank, its body is well shielded, but an escaping door and tube across the outer fuselage-tank is necessary, which is a structural nightmare. At the same time there is no need for jettisoning the central fuel tank and its main engine, whose costs might be approximately the same as the cost of the main reflector which could be 5 meters in diameter, and it could be thermally stabilized.

Referring to FIG. 1, - 2,- and 3, it should be comprehended that the space-shuttle as well as part of the observatrory would require ablation layers and the outer fuel tank of the fuselage towards to nose have to accommodate a frontal lamding geer.

1. A Spaceshuttle Observatory of a singular system, in which the main lifting body of the spaceshuttle has a double ringed fuselage for a fixed outer fuel tank, and an unfixed inner fuel tnak, the latter with a singular but big rocket engine, which could slide outwarly, when empty or almost empty, or it could be jettisoned completely, but when it is sliding outwardly, it could pull either secondary reflector of a “telescope”, or a main reflector with its observatory to the centre of the fuselage, whose outer fuel tank has an inner tubular body, suitable for holding an observatory and its mirrors in sliding, but also in fixable positions, and when the observatory is pulled down with its main reflector, it is the secondary which is fixed at the top, or alternatively, when it is the secondary which is pulled down, it is the observatory which is fixed at the top, holding the main reflector always towards the secondary, using an opening either at the top part of the fuselage or at its bottom part (tail), and in both cases the central fuel tank could be pulled out completely, or only partially, but finally it could be pushed back again completely, closing the telescope-parts back to a small top-space.

2. A Spaceshuttle Observatory as claimed in claim 1 in which the “telescope” is nothing else but the inner tubular wall of the outer fuel tank, holding specially designed cog-rails parallel with its centre-line, on which the inner bodies could slide.

3. A Spaceshuttle Observatory as claimed in claim 1 and 2 in which the “telescope” and observatory could work towards either side, but when it works towards the frontal side, it employs a star-door on the nozzle arond the secondary.

4. A Spaceshuttle Observatory as claimed in claims 1, 2, and 3, in which the outer surface of the whole system is covered with a protective ablation layer, which offers easy openings for a star-door system if required.

5. A Spaceshuttle Observatory as claimed in any of the previous claims in which the parts of the observatory are always kept inside the fuselage, and only the central fuel tank is released or pushed back, if required.

6. A Spaceshuttle Observatory as claimed in any of the previous claims, in which the wing-tips are used as turnable radiation collectors.

7. A Spaceshuttle Observatory as claimed an any of the previous claims, that in reentry the whole system could be pushed together again into a singular unit, capable for landing on a suitable airfield.
